(19) United States
(12) Patent Application Publication
(10) Pub. No.: US 2017/0141842 A1
(43) Pub. Date: May 18, 2017

(54) METHODS AND ARRANGEMENTS FOR POWER EFFICIENT REVERSE DIRECTION COMMUNICATIONS

(71) Applicants: Solomon B. Trainin, Haifa (IL); Gadi Shor, Tel Aviv (IL)

(72) Inventors: Solomon B. Trainin, Haifa (IL); Gadi Shor, Tel Aviv (IL)

(73) Assignee: INTEL IP CORPORATION, Santa Clara, CA (US)

(21) Appl. No.: 15/300,275

(22) PCT Filed: Mar. 29, 2014
(86) PCT No.: PCT/US2014/032281

§ 371 Date: Sep. 28, 2016

(51) Int. Cl. H04B 7/26; H04L 1/00; H04W 72/14

(52) U.S. Cl. CPC H04B 7/2612; H04W 72/14; H04L 1/0025; H04L 69/323

(57) ABSTRACT

Logic may enable reverse direction communication with improved power efficiency. Logic may transmit a packet to a Responder during a transmission opportunity with an indication of a reverse direction grant. Logic may receive a response to the packet indicative of a lack of data packets to transmit by the Responder. Logic may enter a defer transmission mode in which transmissions are deferred during the transmission opportunity for greater than a point coordination function interframe space (PIFS) within the transmission opportunity. Logic may grant data transmission rights of the transmission opportunity during the defer transmission mode to the Responder. Logic may grant a contention-based data transmission rights of the transmission opportunity during the defer transmission mode. Logic may grant data transmission rights of the transmission opportunity during the defer transmission mode to the Granter.

### TECHNICAL FIELD

Embodiments are in the field of wireless communications. More particularly, embodiments may involve reverse direction communications in a power efficient manner.

### BACKGROUND

A wireless local area network (WLAN) may include a basic service set (BSS). The BSS may include an access point (AP) or personal basic service set control point (PCP) and one or more stations (STA). The AP or PCP may transmit data frames to the one or more stations over a downlink channel and may receive data frames over an uplink channel. In a high throughput WLAN, the uplink and the downlink channels may employ an intensive traffic of data frames. The BSS may include a Direct Link Service (DLS) to allow the stations to transfer data between the stations without the AP intervention. The sequence of frames that may be used to transmit data from one station to one or more other stations, and to receive a response(s) from the one or more stations, may be referred to as a transmit sequence. The transmit sequence may include an aggregation of data units which may be transmitted by an Initiator, and one or more response frames from a Responder. For example, the Initiator may be an AP and the Responder may be a mobile unit.

In WLAN, a collision of transmissions from different mobile units and the AP may occur. In order to avoid collisions, the AP may initiate a transmit opportunity (TxOP) time slot. In the TxOP time slot the AP, for example, an Initiator may transmit data frames to a mobile station (e.g. a Responder). Up until a recent innovation, only an owner of the TxOP would be allowed to transmit during the TxOP time slot.

The recent innovation is a Reverse Direction protocol. According to the Reverse Direction protocol, a Reverse Direction (RD) Responder may transmit the initial physical layer convergence procedure (PLCP) protocol data unit (PPDU) of the RD response burst a short interframe space (SIFS) after the reception of a Reverse Direction Grant (RDG) PPDU (9.25.4 Rules for RD Responder, IEEE Std 802.11ad-2012). If there is no data ready in the Responder, the Responder cannot postpone delivery of the data to the later time in the same TxOP.

### BRIEF DESCRIPTION OF THE DRAWINGS

FIG. 1 depicts an embodiment of a wireless network comprising a plurality of communications devices with reverse direction logic;

FIG. 2A depicts an embodiment of a timing diagram of a reverse direction communication procedure that grants data transmission rights to a Responder;

FIG. 2B depicts an embodiment of a timing diagram of a reverse direction communication procedure that grants data transmission rights to either the Granter or the Responder with contention-based access;

FIG. 2C depicts an embodiment of a timing diagram of a reverse direction communication procedure that grants data transmission rights to a Granter;

FIG. 3 depicts an embodiment of a flowchart by a Granter to implement a reverse direction communication procedure;

FIG. 4 depicts an embodiment of a flowchart by a Responder to implement a reverse direction communication procedure; and

FIGS. 5A-B depict embodiments of flowcharts to transmit, receive, decode, and interpret communications with frames as illustrated in FIGS. 1-2.

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

References to “one embodiment,” “an embodiment,” “example embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In the current Reverse Direction protocol, if the Responder does not have data ready to send immediately upon an offer by the Initiator, hereafter referred to as the Reverse Direction (RD) Granter, the Responder cannot postpone delivery of the data to the later time in the same transmit opportunity (TxOP). If the RD Granter wants to enable a Responder to deliver its data in the current TxOP, the RD Granter may, after the Responder indicates that it has no data to transmit, issue another RD Grant after an interframe space. The Responder, again, must respond immediately after an interframe space with data or with an indication that there is no data available to transmit. The Responder cannot delay the response. This cycle can continue with no guarantee that the Responder will have data available during the TxOP. Furthermore, the repeated transmissions of the RD Grants and the responses with no data prevent both the RD Granter and the Responder to from entering lower power transmission and reception modes.

Embodiments may allow the Responder to delay its response while the RD Granter and, in many embodiments, the Responder to remain in a low power consumption mode. In several embodiments, the RD Granter may respond an interframe space after with a Reverse Direction Grant (RDG) physical layer convergence procedure (PLCP) protocol data unit (PPDU). The RDG PPDU may comprise a field such as a subfield of a frame control field or a subfield of a high throughput control field with one or more bits indicative of an RDG. Then the RD Granter may receive a response from the Responder indicating that the Responder has no more data available to transmit. If the RD Granter might receive data from the Responder during the TxOP or might receive data to transmit to the Responder during the TxOP, the RD Granter may determine to enter a deferred transmission mode. In the deferred transmission mode, transmissions may be deferred for a duration that is greater than a point coordination function (PCF) interframe space (PIFS) and within the TxOP. In some embodiments, the deferred transmission mode may defer transmissions for an indefinite duration within the TxOP. In further embodiments, the deferred transmission mode may defer transmissions for a duration determined by the RD Granter based upon receipt or generation of data. In still further embodiments, the deferred transmission mode may defer transmissions for a duration determined by the Responder based upon the receipt of or generation of data.

In many embodiments, the deferred transmission mode may defer transmissions by granting data transmission rights to the RD Granter, the Responder, or both the RD Granter and the Responder. These deferred transmission modes are referred to as the Granter Deferred transmission mode, the Responder Deferred transmission mode, and the Random Access Deferred transmission mode, respectively. Some embodiments may implement one of these modes. Some embodiments may implement more than one of these modes. And some embodiments may implement all of these modes.

In many embodiments, after the end of a deferred transmission mode, the data transmission rights of the TxOP is may be returned to the RD Granter (the data transmission rights of the TxOP may be reset). Thereafter, the RD Granter and the Responder may enter another deferred transmission mode if there is sufficient time remaining in the TxOP. The latter deferred transmission mode may be any one of the modes above or any other mode, depending upon the capabilities of the RD Granter and the Responder.

In the Granter Deferred transmission mode, embodiments may grant data transmission rights of the TxOP to the RD Granter. In many of these embodiments, the RD Granter may initiate a communication with the Responder at any time during the TxOP by transmitting a frame and, in some embodiments, the communication may be preceded by a specific type of frame such as a control frame. In some embodiments, the control frame may comprise a ready-to-send (RTS). In many embodiments, the RTS may be transmitted with modulation and coding scheme zero (MCS0).

The RD Granter and the Responder may perform a pattern of communications to enter the Granter Deferred transmission mode. Upon entering the Granter Deferred transmission mode, the Responder may not initiate a communication until a SIFS after the RD Granter's communication with the Responder.

The Granter Deferred transmission mode may reduce power consumption by reducing transmission and reception of repeated RDGs, which allows the RD Granter to enter a low power or sleep mode. In some embodiments, the Responder may also to switch to MCS0 to receive an RTS from the RD Granter, which can consume substantially less power than support of multiple antennas in a receiver (RX) trained mode that may be associated with higher level modulation and coding schemes.

In the Responder Deferred transmission mode, embodiments may grant data transmission rights of the TxOP to the Responder. In many of these embodiments, RD Granter and the Responder may perform a pattern of communications to enter the Responder Deferred transmission mode. Thereafter, the Responder may initiate a communication with the RD Granter at any time during the TxOP. In some embodiments, the communication may be preceded by a clear-to-send (CTS) and the RD Granter may not initiate a communication until a SIFS after the Responder's communication.

The Responder Deferred transmission mode may reduce power consumption by deferring communications between the RD Granter and the Responder until the Responder is ready to communicate with the RD Granter. In many embodiments, the Responder Deferred transmission mode may allow the Responder to enter a low power or sleep mode. In some embodiments, the RD Granter may switch to the MCS0, which may consume less power than maintaining antenna(s) in a mode to receive communications at a higher-level modulation and coding scheme.

In the Random Access Deferred transmission mode, embodiments may grant contention-based data transmission rights of the TxOP to the RD Granter and the Responder. In many of these embodiments, the Random Access Deferred transmission mode may be entered by a pattern of communications between the RD Granter and the Responder. Thereafter, either the RD Granter or the Responder may initiate a communication. In some embodiments, the communication may be preceded by an RTS at MCS0. In several embodiments, if the RD Granter and the Responder attempt to access the channel at the same time, the RD Granter and the Responder may follow a contention-based protocol such as carrier sense multiple access with collision avoidance (CSMA/CA). In many embodiments, if the RD Granter and the Responder attempt to access the channel at the same time, the RD Granter and the Responder may independently determine random backoff times and, upon expiration of the random backoff times, check the channel again to determine whether the channel is available to transmit a communication. Since the backoff times are random, it is likely that one of the devices will find the channel clear on the next attempt and transmit, e.g., an RTS to alert the other device to prepare to receive a communication.

The Random Access deferred transmission mode may reduce power consumption by deferring communications until either the RD Granter or the Responder is ready to communicate. In some embodiments, the Random Access deferred transmission mode may allow both the RD Granter and the Responder to switch to the MCS0 to receive an RTS at MCS0.

Various embodiments may be designed to address different technical problems associated with reverse direction communications in a power efficient manner. Other technical problems may include providing data transmission rights to the Responder without repeating reverse direction grant after every SIFS, maintaining multiple antennas trained for directional communications in both the Granter and Responder, and/or the like.

Different technical problems such as those discussed above may be addressed by one or more different embodiments. For instance, some embodiments that address reverse direction communications in a power efficient manner may do so by one or more different technical means such as entering a deferred transmission mode, granting data transmission rights to the Responder, granting data transmission rights to the Responder and withdrawing grant of data transmission rights from Responder to enter the deferred transmission mode, granting a contention-based data transmission rights, establishing a low power control frame to exit the deferred transmission mode, and/or the like.

Some embodiments implement WirelessHD Specification Version 1.1D1, May 2010. Several embodiments may implement Ecma International, Standard ECMA-387, High Rate 60 GHz PHY, MAC and PALS, 2nd Ed., December 2010. Further embodiments may implement Wireless Gigabit Alliance, WiGig 1.1 specification, June 2011. Some embodiments implement Institute of Electrical and Electronic Engineers (IEEE) 802.11 systems such as IEEE 802.11ad systems and other systems that operate in accordance with standards such as the IEEE 802.11-2012, IEEE Standard for Information technology—Telecommunications and information exchange between systems—Local and metropolitan area networks—Specific requirements—Part 11: Wireless LAN Medium Access Control (MAC) and Physical Layer (PHY) Specifications (http://standards.ieee.org/getieee802/download/802.11-2012.pdf).

Some embodiments implement Institute of Electrical and Electronic Engineers (IEEE) 802.15 systems such as IEEE 802.15.3 systems and other systems that operate in accordance with standards such as the IEEE 802.15, IEEE Standard for Information technology—Telecommunications and information exchange between systems—Local and metropolitan area networks—Specific requirements—Part 15.3: Wireless Medium Access Control (MAC) and Physical Layer (PHY) Specifications for High Rate Wireless Personal Area Networks (WPANs), IEEE Computer Society, The Institute of Electrical and Electronics Engineers, Inc., 3 Park Avenue, New York, N.Y., 29 Sep. 2003.

Some embodiments are particularly directed to improvements for wireless local area network (WLAN), such as a WLAN implementing one or more Institute of Electrical and Electronics Engineers (IEEE) 802.11 standards (sometimes collectively referred to as “Wi-Fi”, or wireless fidelity).

Some embodiments, implement the Bluetooth® specification (e.g. BLUETOOTH SPECIFICATION Version 4.0, Bluetooth SIG, Inc., Publication date: 30 Jun. 2010). The embodiments, however, are not limited to these standards.

Several embodiments comprise Personal Basic Service Set (PBSS) Central Point, or PCP for and/or client devices of PCPs or stations (STAs) such as docking stations, routers, switches, servers, workstations, netbooks, mobile devices (Ultra book, Laptop, Smart Phone, Tablet, and the like).

Logic, modules, devices, and interfaces herein described may perform functions that may be implemented in hardware and/or code. Hardware and/or code may comprise software, firmware, microcode, processors, state machines, chipsets, or combinations thereof designed to accomplish the functionality.

Embodiments may facilitate wireless communications. Some embodiments may comprise low power wireless communications like Bluetooth®, wireless local area networks (WLANs), wireless metropolitan area networks (WMANs), wireless personal area networks (WPAN), cellular networks, communications in networks, messaging systems, and smart-devices to facilitate interaction between such devices. Furthermore, some wireless embodiments may incorporate a single antenna while other embodiments may employ multiple antennas. The one or more antennas may couple with a processor and a radio to transmit and/or receive radio waves. For instance, multiple-input and multiple-output (MIMO) is the use of radio channels carrying signals via multiple antennas at both the transmitter and receiver to improve communication performance.

This disclosure is not limited to WLAN related standards, but may also apply to wireless wide area networks (WWANs) and 3G or 4G wireless standards (including progenies and variants) related to wireless devices, user equipment or network equipment included in WWANs. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1×RTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The examples are not limited in this context.

While some of the specific embodiments described below will reference the embodiments with specific configurations, those of skill in the art will realize that embodiments of the present disclosure may advantageously be implemented with other configurations with similar issues or problems.

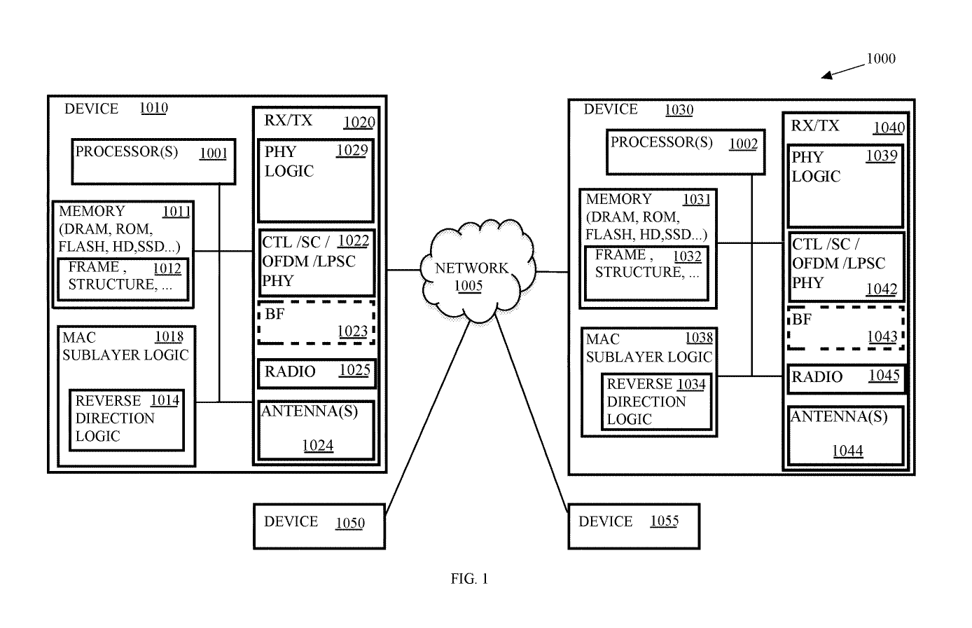

Turning now to FIG. 1, there is shown an embodiment of a wireless communication system 1000. The wireless communication system 1000 comprises a communications device 1010 that may be wire line and wirelessly connected to a network 1005. The communications device 1010 may communicate wirelessly with a plurality of communication devices 1030, 1050, and 1055 via the network 1005. The communications device 1050 may comprise a low power communications device such as a consumer electronics device, a personal mobile device, an ultra book, or the like. The communications device 1030 may comprise a low power communications device such as a consumer electronics device, a personal mobile device, an ultra book, or the like, in the network 1005 of the communications device 1010. The communications device 1050 may comprise a docking station that functions as an access point (AP) and/or a Personal Basic Service Set (PBSS) Control Point (PCP). And communications device 1055 may comprise printers, laptops, netbooks, cellular phones, smart phones, PDAs, or other wireless-capable devices that also operate as stations. Thus, communications devices may be communicatively coupled via the network 1005 and be mobile or fixed.

Note that a system 1000, according to some embodiments, may include a System on a Chip (SOC) having the components of each device as shown in FIG. 1, excluding the antenna(s). In other words, an SOC may comprise all the components of the communications device(s) 1010, 1030, 1050, and/or 1055, with the exception of the antennas such as the antennas 1024 and 1044. In some embodiments, the SOC may also include one or more radios such as the radios 1023 and 1043. In several embodiments, the one or more radios may compule with the physical layer (PHY) logic such as PHY logic 1019 and 1039. Furthermore, the system 1000 may comprise one or more antennas coupled with corresponding ones of the one or more radios.

The communications device 1010 may utilize antenna(s) 1024 to communicate within one or more stations, such as communication devices 1030, 1050, and 1055, via one or more antenna sectors. The communications device 1050 may act as a network coordinator to coordinate communications among the plurality of communication devices 1010, 1030, and 1055 and control access to the wireless medium. When acting as the network coordinator, the communications device 1050 may broadcast a beacon frame that allocates a time slot to the communications device 1010 during a subsequent beacon interval. In other embodiments, the communications device 1010 may obtain the time slot, or transmission opportunity, by a contention-based protocol such as carrier sense multiple access with collision avoidance (CSMA/CA).

During the transmission opportunity (TxOP), the communications device 1010 may transmit one or more packets to the communications device 1030. In the last packet transmitted by the communications device 1010, the reverse direction logic 1014 of medium access control (MAC) sublayer logic 1018 in the communications device 1010 may set one or more bits to indicate that the communications device 1010 is offering to grant data transmission rights of the TxOP to the communications device 1030.

The communications device 1030 may comprise MAC sublayer logic 1038 with reverse direction logic 1034. The reverse direction logic 1034 may respond to the last packet with data packets if data is available to transmit to the communications device 1010 and may indicate in a final response packet that the communications device 1030 has no more data available to transmit to the communications device 1010. The communications device 1030 may not have data available because the communications device 1030 may not have completed processing the data, the communications device 1030 may not have received the data from another source, the communications device 1030 may not have has not made the data available to the MAC sublayer logic logic 1038, or any other reason that the communications device 1030 may not have more data available for immediate transmission in the response a short interframe space (SIFS) after receipt of the last packet from the communications device 1010.

In many embodiments, the reverse direction logic 1014 of the communications device 1010 may determine to enter a deferred transmission mode. In the deferred transmission mode, transmissions may be deferred for a duration that is greater than a point coordination function (PCF) interframe space (PIFS) and within the TxOP. In some embodiments, the deferred transmission mode may defer transmissions for an indefinite duration within the TxOP. In further embodiments, the deferred transmission mode may defer transmissions for a duration determined by the communications device 1010 based upon receipt of or generation of data. And, in further embodiments, the deferred transmission mode may defer transmissions for a duration determined by the communications device 1030 based upon the receipt of or generation of data.

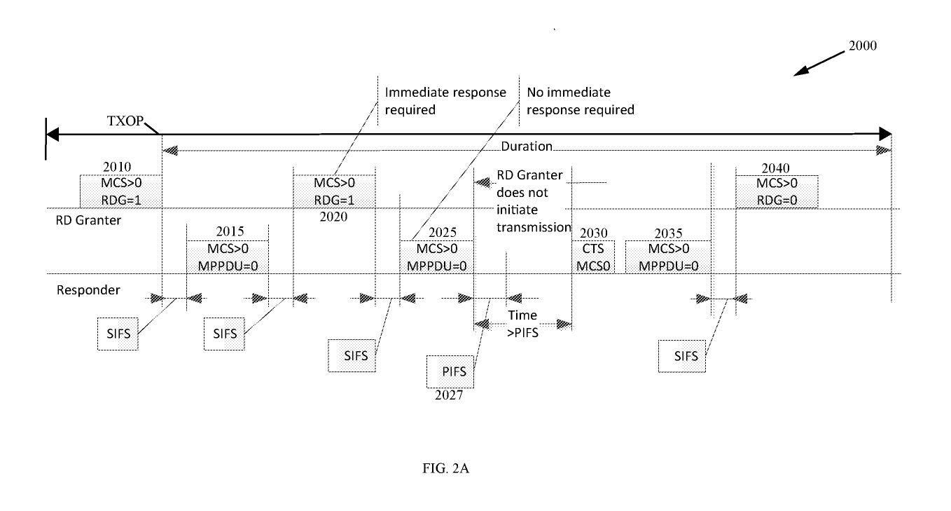

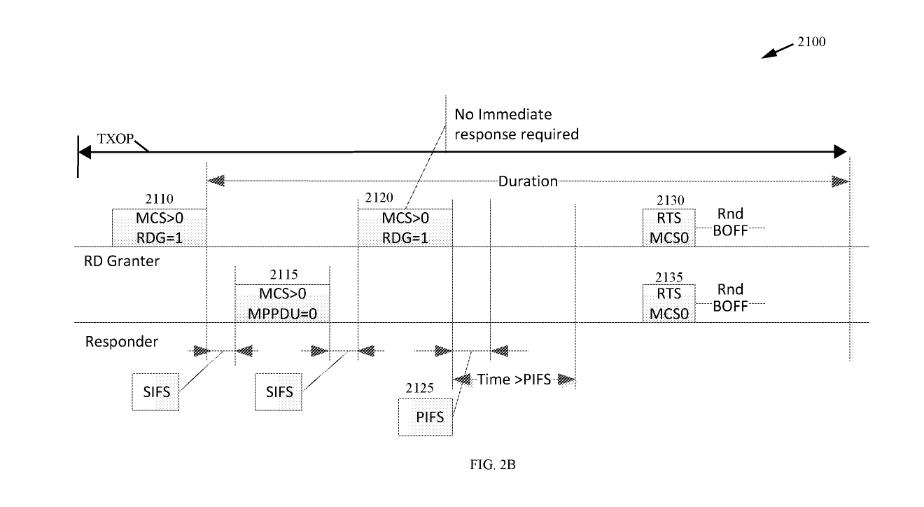

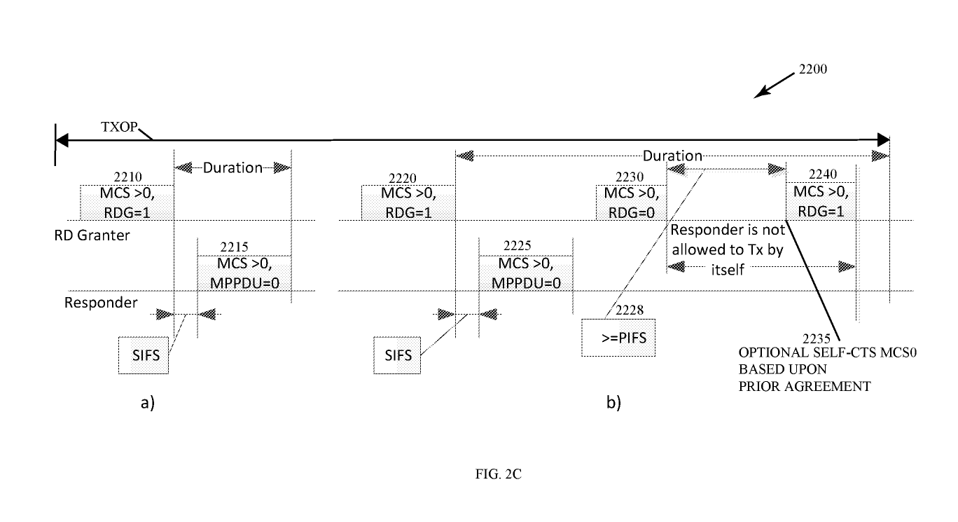

Referring also the FIGS. 2A-C, there are shown three different embodiments of timing diagrams that illustrate different deferred transmission modes. FIG. 2A illustrates an embodiment of a timing diagram of a reverse direction communication procedure for a Responder Deferred transmission mode that grants data transmission rights of a TxOP to a Responder. FIG. 2B illustrates an embodiment of a timing diagram of a reverse direction communication procedure for a Random Access Deferred transmission mode that grants data transmission rights of a TxOP to either the Granter or the Responder with contention-based access. And FIG. 2C illustrates an embodiment of a timing diagram of a reverse direction communication procedure for a Granter Deferred transmission mode that grants data transmission rights of a TxOP to a Granter.

In several embodiments, the deferred transmission mode may grant data transmission rights of the TxOP to the communications device 1030 (also referred to as the Responder). The timing diagram 2000 of FIG. 2A illustrates an embodiment of the Responder Deferred transmission mode. In this embodiment, the reverse direction logic 1014 and 1034 may determine, based upon the communications between the communications devices 1010 and 1030, that, in accordance with the deferred transmission mode, the MAC logic 1018 and 1038 may grant data transmission rights of the TxOP to the communications device 1030.

More specifically, the timing diagram 2000 illustrates the communications device 1010 transmits a PPDU 2010 with the RDG set to a logical one to indicate that the communications device 1010 is granting data transmission rights of the TxOP to the communications device 1030. The communications device 1030 may respond with a PPDU 2015 that indicates that the communications device 1030 does not have further data to transmit and also requires that the communications device 1010 to continue immediately. The transmission of the PPDU 2015 returns data transmission rights of the TxOP to the communications device 1010, which may represent a refusal to utilize data transmission rights of the TxOP.

In many embodiments, the reverse direction logic 1014 of the communications device 1010 may indicate an interframe space after with a RDG PPDU 2020 that comprises a field with one or more bits indicative of an RDG set to a logical one and may include an indication that an immediate response is required.

The combination of the RDG set to one and the requirement of the immediate response may indicate to the communications device 1030 that the communications device 1010 may wait for the communications device 1030 to initiate a communication with the communications device 1010. In some embodiments, the communications device 1010 and the communications device 1030 may have a previously established agreement indicating that the communications device 1030 has to start its deferred activity via a CTS 2030 that is transmitted with MCS0. In this case, the communications device 1010 may wait for the communications device's 1030 transmission in an Rx mode that consumes less power due to activation of a single antenna in a Control PHY only mode.

On the other hand, if the communications device 1010 does not receive the response PPDU 2025, the communications device 1010 may continue with retries, i.e., transmitting PPDUs with RDG set to one with a request for an immediate response. As a result, the risk of wasting the remaining duration of the TxOP lowers. For instance, if the communications device 1030 wrongfully starts its transmission, the communications device 1010 sent its PPDU 2025 in SIFS time after getting response from the communications device 1030, and no PHY-RXSTART indication appears at the communications device 1030, some frames transmitted by the communications device 1030 may be lost. However, the communications device 1010 is still in possession of the TxOP and will lead to recovery of the TxOP.

After receiving the second response PPDU 2025, the communications device 1010 is not allowed to transmit frames until end of the duration remaining in the TxOP or until the communications device 1010 receives from the communications device 1030 a frame with an indication that the communications device 1030 has no more frames to send (MPPDU=0). In several embodiments, MPPDU=0 represents that the value of the More PPDUs field of a frame is set to zero to indicate that no more PPDUs are available to send. If the multiple PPDUs are transmitted together, the PPDUs preceding the final PPDU in the transmission may have MPPDU set to one and only the last PPDU in the transmission may have MPPDU set to zero.

If the communications device 1010 and the communications device 1030 have an agreement that the communications device 1030 starts its deferred transmission with a control frame, the communications device 1010 may switch to an Rx low power mode a PIFS 2027 after receiving the response frame, PPDU 2025. If the reverse direction logic 1014 does not respond within a PIFS 2027 after transmitting the PPDU 2025, the communications device 1030 may initiate a communication with the communications device 1010 at any time during the TxOP with a self clear to send (CTS) 2030 and the communications device 1010 may not initiate a communication until a SIFS after the Responder's communication. In such embodiments, the communications device 1010 may switch its antennas to receive (Rx) trained configuration after receiving the self-CTS 2030. The communications device 1010 may then receive one or more data frames illustrated by the PPDU 2035 with the MCS greater than zero and the indication that there are no more PPDU data packets to transmit (MPPDU=0).

Upon receipt of PPDU 2035, data transmission rights of the TxOP are returned to the communications device 1010. If there is sufficient time remaining in the TxOP for one or more additional transmissions, the communications device 1010 may transmit one or more frames to the communications device 1030 and, in some embodiments, the communications device 1010 may initiate another deferred transmission mode such as any of the transmission modes illustrated in FIGS. 2A-C.

Referring now to FIGS. 1 and 2B, there is shown an embodiment of a timing diagram 2100 of a reverse direction communication procedure that grants contention-based data transmission rights to an RD Granter (communications device 1010) and a Responder (communications device 1030). The timing diagram 2100 illustrates an embodiment of the Random Access Deferred transmission mode. In this embodiment, the reverse direction logic 1014 and 1034 may determine, based upon the communications between the communications devices 1010 and 1030, that, according to the deferred transmission mode, the reverse direction logic 1014 and 1034 may grant data transmission rights of the TxOP to the communications device 1010 and the communications device 1030 via a contention-based access protocol.

The communications device 1010 may transmit a PPDU 2110 with the RDG set to a logical one to indicate that the communications device 1010 is granting data transmission rights of the TxOP to the communications device 1030. The communications device 1030 may respond with a PPDU 2115 a SIFS after that indicates that the communications device 1030 does not have further data to transmit (MPPDU=0) and that also requires the communications device 1010 to respond immediately, returning data transmission rights of the TxOP to the communications device 1010.

In many of these embodiments, the communications device 1010 may transmit a second PPDU 2120 with the RDG set and an indication that no immediate response is required. The combination of the RDG set to one and no requirement of the immediate response indicates to the communications device 1030 that the communications device 1010 is offering to enter the Random Access Deferred transmission mode. To enter the Random Access Deferred transmission mode, neither the communications device 1010 nor the communications device 1030 may respond during a PIFS 2125. If no response is received from the communications device 1030 during PIFS 2125 time, the communications device 1010 may not continue sending frames and may switch to a less power consuming Omni-directional reception/Control PHY mode.

Once the Random Access deferred transmission mode is established, either the communications device 1010 or the communications device 1030 may initiate a communication. In some embodiments, the communications device 1010 or the communications device 1030 may initiate a communication with a frame such as an RTS 2130 and an RTS 2135.

The communications devices 1010 and 1030 may compete for link access next time they attempt to transmit data. Until the end of the duration time remaining in the TxOP, both the communications devices 1010 and 1030 may issue the RTS's 2130 and 2135, respectively. If the communications devices 1010 and 1030 attempt to access the channel at the same time, the communications devices 1010 and 1030 may follow a contention-based protocol such as carrier sense multiple access with collision avoidance (CSMA/CA). In many embodiments, if the communications devices 1010 and 1030 attempt to access the channel at the same time, the communications devices 1010 and 1030 may independently determine random backoff times (RND BOFF) and, upon expiration of the random backoff times, the communications devices 1010 and 1030 check the channel again. The backoff may be reset after receiving a CTS responsive to the RTS.

In some embodiments, after a one of the communications devices 1010 and 1030 successfully obtains data transmission rights of the channel via a contention-based protocol and transmits a communication to the other communications device, the Random Access deferred transmission mode may end and the data transmission rights of the channel may return to the communications device 1010. In other embodiments, the Random Access Deferred mode continues until termination or expiration of the TxOP.

Referring now to FIGS. 1 and 2C, there is shown an embodiment of a timing diagram 2200 of a reverse direction communication procedure that grants data transmission rights to an RD Granter (communications device 1010). The timing diagram 2200 illustrates an embodiment of the Granter Deferred transmission mode. In this embodiment, the reverse direction logic 1014 and 1034 may determine, based upon the communications between the communications devices 1010 and 1030 that, according to the deferred transmission mode, the reverse direction logic 1014 and 1034 may grant data transmission rights of the TxOP to the communications device 1010.

The communications device 1010 may transmit a PPDU 2210 with the RDG set to a logical one to indicate that the communications device 1010 is granting data transmission rights of the TxOP to the communications device 1030. The communications device 1030 may respond with a PPDU 2215 that indicates that the communications device 1030 does not have further data to transmit (MPPDU=0) and that also requires the communications device 1010 to continue immediately, returning data transmission rights of the TxOP to the communications device 1010.

The communications device 1010 may transmit a PPDU 2220 with an RDG set to a logical one that does require immediate response in this deferred transmission mode. In the case that the communications device 1010 requires and receives a response of PPDU 2225 from the communications device 1030, the communications device 1010 may enter the deferred transmission mode by transmitting to the PPDU 2225 with a PPDU 2230. The PPDU 2230 has RDG set to zero to indicate that the communications device 1010 is maintaining data transmission rights of the TxOP and not passing data transmission rights to the communications device 1030 at this point. After receiving the PPDU 2230, the communications device 1030 may not initiate a communication until a SIFS after a communication from the communications device 1010 in which the RDG in the communication is set to a logical one.

At a point later in time that may be greater than a PIFS 2228 and within the TxOP, the communications device 1010 may determine to either transmit one or more packets of data to the communications device 1030 wherein RDG is set to a logical one (RDG=1) in the last of the data packets, or may just transmit a PPDU 2240 with an RDG set to a logical one. The transmission of PPDU 2240 with RDG=1 transfers data transmission rights of the TxOP to the communications device 1030, allowing the communications device 1030 to initiate a transmission to the communications device 1010 if there is sufficient time remaining in the TxOP for the transmission.

In many embodiments, the communications device 1010 may have an agreement with the communications device 1030 to precede the transmission of the PPDU 2240 with a self-CTS 2235 at MCS0. Such an agreement may allow the communications device 1030 to enter a lower power mode while awaiting an amount of time that may not be defined for the communications device 1010 to transmit the PPDU 2240 or a number of packets including the PPDU 2240 with RDG=1 in the last packet.

Referring again to FIG. 1, the network 1005 may represent an interconnection of a number of networks. For instance, the network 1005 may couple with a wide area network such as the Internet or an intranet and may interconnect local devices wired or wirelessly interconnected via one or more hubs, routers, or switches. In the present embodiment, the network 1005 communicatively couples communications devices 1010, 1030, 1050, and 1055.

The communication devices 1010 and 1030 comprise processor(s) 1001 and 1002, memory 1011 and 1031, and MAC sublayer logic 1018 and 1038, respectively. The processor(s) 1001 and 1002 may comprise any data processing device such as a microprocessor, a microcontroller, a state machine, and/or the like, and may execute instructions or code in the memory 1011 and 1031. The memory 1011 and 1031 may comprise a storage medium such as Dynamic Random Access Memory (DRAM), read only memory (ROM), buffers, registers, cache, flash memory, hard disk drives, solid-state drives, or the like. The memory 1011 and 1031 may be coupled with the MAC sublayer logic 1018 and 1038, respectively, and/or may be coupled with the PHY devices, transceiver 1020 and 1040, respectively. In many embodiments, the memory 1011 and 1031 may comprise memory 1012 and 1032, respectively. The memory 1012 and 1032 may be allocated to store the frames and/or the frame structures, as well as frame headers or portions thereof. In many embodiments, the frames may comprise fields based upon the structure of the standard frame structures identified in IEEE 802.11.

The MAC sublayer logic 1018 and 1038 may comprise logic to implement functionality of the MAC sublayer of the data link layer of the communications devices 1010 and 1030, respectively. The MAC sublayer logic 1018 and 1038 may generate the frames such as management frames, data frames, and control frames, and may communicate with the PHY logic 1029 and 1039, respectively. The PHY logic 1029 and 1039 may generate physical layer protocol data units (PPDUs) based upon the frames. More specifically, the frame builders may generate frames and the data unit builders of the PHY logic 1029 and 1039 may prepend the frames with preambles to generate PPDUs for transmission via a physical layer (PHY) device such as the transceivers (RX/TX) 1020 and 1040, respectively.

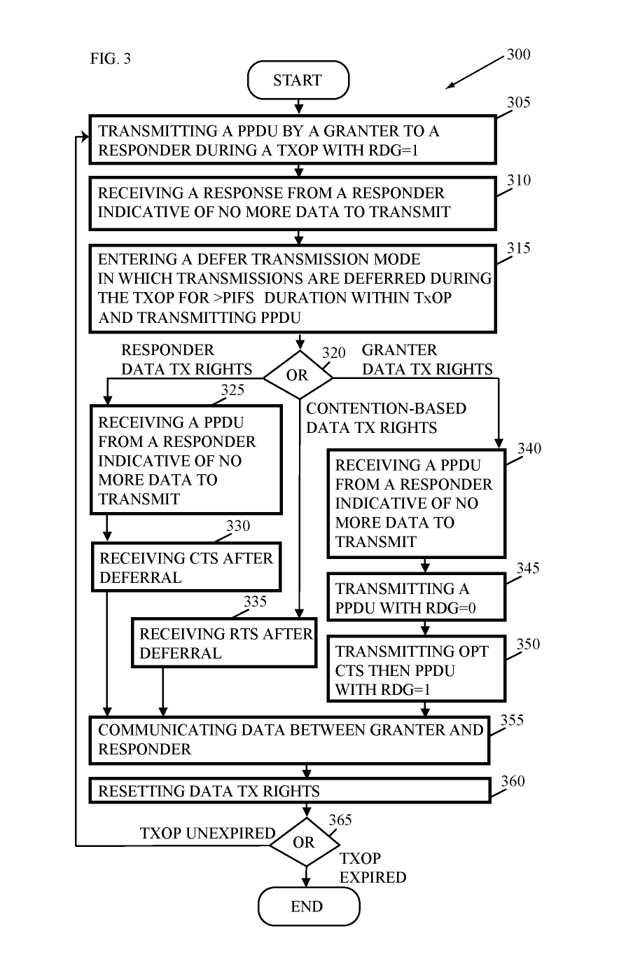

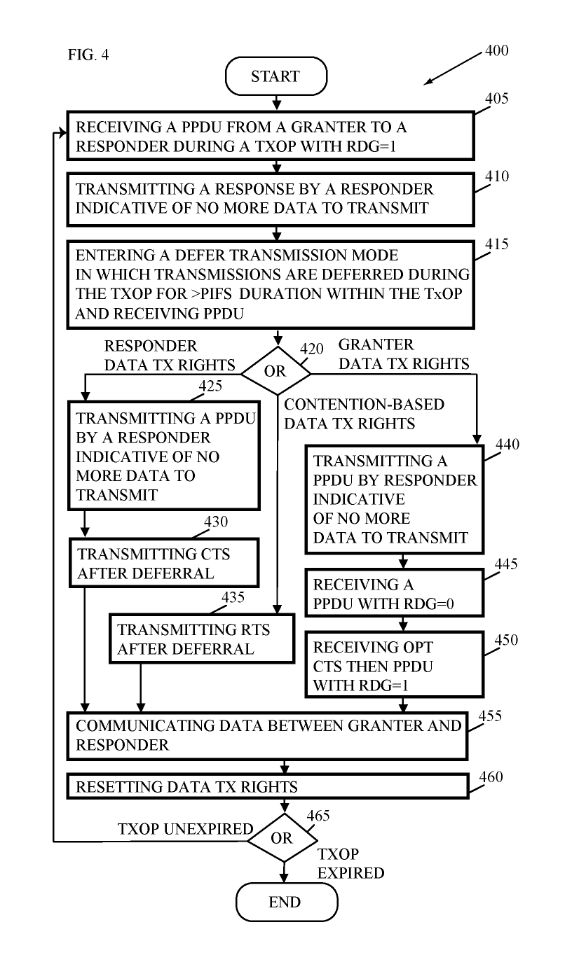

In the present embodiment, the MAC sublayer logic 1018 and 1038 may comprise reverse direction logic 1014 and 1034 to implement to procedures for reverse direction communications such as the procedures described in conjunction with the flowcharts 300 and 400 illustrated in FIGS. 3 and 4.

The MAC frame, also referred to as MAC layer Service Data Units (MSDUs), may comprise, e.g., a management frame. For example, a frame builder may generate a management frame such as the beacon frame to identify the communications device 1010 as having capabilities such as supported data rates, power saving features, cross-support, and a service set identification (SSID) of the network to identify the network to the communications device 1030. The MAC sublayer logic 1018 may pass the frame to the PHY logic 1029 and the PHY logic 1029 may prepend a preamble to generate a PHY frame prior to transmitting the PHY frame. The PHY frame is also referred to as a PPDU.

The communications devices 1010, 1030, 1050, and 1055 may each comprise a transmitters and receivers such as transceivers (RX/TX) 1020 and 1040. In many embodiments, transceivers 1020 and 1040 implement four different PHY layers: Control PHY, SC (single carrier) PHY, OFDM PHY and low-power SC PHY (LPSC PHY). Control PHY is modulation and coding scheme 0 (MCS0). SC starts at MCS1 and ends at MCS12; OFDM PHY starts at MCS13 and ends at MCS24; and LPSC starts at MCS25 and ends at MCS31. MCS0 to MCS4 may be mandatory PHY MCSs.

In the present embodiments, the CTL/SC/OFDM/LPSC PHY 1022 and 1042 represent modules of hardware and code to implement these different modulation and coding schemes. Note that this is just illustrative of the schemes that may be included in many embodiments but embodiments are not so limited. For example, other embodiments may only have one or more MCS's of the Control PHY and SC PHY or one or more MCS's of the Control PHY, SC PHY, and OFDM.

The CTL/SC/OFDM/LPSC PHY 1022 and 1042 may implement a method of encoding digital data on multiple carrier frequencies. The CTL/SC/OFDM/LPSC PHY 1022 and 1042 may comprise a frequency-division multiplexing scheme used as a digital multi-carrier modulation method. Data may be carried in a large number of closely spaced orthogonal subcarrier signals. The data may be divided into several parallel data streams or channels, one for each subcarrier. Each subcarrier may be modulated with a modulation scheme at a low symbol rate, maintaining total data rates similar to conventional single-carrier modulation schemes in the same bandwidth.

An OFDM system uses several carriers, or “tones,” for functions including data, pilot, guard, and nulling. Data tones are used to transfer information between the transmitter and receiver via one of the channels. Pilot tones are used to maintain the channels, and may provide information about time/frequency and channel tracking. And guard tones may help the signal conform to a spectral mask. The nulling of the direct component (DC) may be used to simplify direct conversion receiver designs.

Guard intervals may be inserted between symbols such as between every OFDM symbol as well as between the short training field (STF) and long training field (LTF) symbols in the front end of the transmitter during transmission to avoid inter-symbol interference (ISI). ISI might result from multi-path distortion.

Each transceiver 1020 and 1040 comprises a radio 1025 and 1045, respectively, comprising an RF transmitter and an RF receiver. The CTL/SC/OFDM/LPSC PHY 1022 and 1042 may transform information signals into signals to be applied via the radios 1025 and 1045 to elements of an antenna(s) 1024 and 1044, respectively. An RF receiver receives electromagnetic energy at an RF frequency via elements of an antenna(s) 1024 and 1044 and radios 1025 and 1045, respectively. The CTL/SC/OFDM/LPSC PHY 1022 and 1042 may extract the digital data from the symbols received via the radios 1025 and 1045, respectively.

In some embodiments, the communications device 1010 comprises a Beam Former (BF) 1023. The BF 1023 may comprise a device that performs digital beam forming such as a Digital Beam Former (DBF) or any other process for beam forming. The BF 1023 may process to signals to create directional transmissions based upon constructive and destructive interferences between the waveforms to be applied to elements of antenna(s) 1024. The antenna(s) 1024 may be an array of individual, separately excitable antenna elements. The signals applied to the elements of the antenna(s) 1024 cause the antenna(s) 1024 to radiate one to four spatial channels. Each spatial channel so formed may carry information to one or more of the communications devices 1030, 1050, and 1055.

Similarly, the communications device 1030 comprises the transceiver (RX/TX) 1040 to receive and transmit signals from and to the communications device 1010. The transceiver (RX/TX) 1040 may comprise an antenna(s) 1044 and, optionally, a BF 1043. The elements of the antenna(s) 1044 may receive signals in, e.g., one to four spatial channels and the BF 1043 may be trained to received directional signals from a transmitter.

FIG. 1 may depict a number of different embodiments including a Multiple-Input, Multiple-Output (MIMO) system with, e.g., four spatial streams, and may depict degenerate systems in which one or more of the communications devices 1010, 1030, 1050, and 1055 comprise a receiver and/or a transmitter with a single antenna including a Single-Input, Single Output (SISO) system, a Single-Input, Multiple Output (SIMO) system, and a Multiple-Input, Single Output (MISO) system. In the alternative, FIG. 1 may depict transceivers that include multiple antennas and that may be capable of multiple-user MIMO (MU-MIMO) operation.

FIG. 3 depicts an embodiment of a flowchart 300 by a Granter to implement a reverse direction communication procedure. In particular, FIG. 3 depicts an embodiment of a flowchart 300 to enable reverse direction communication with improved power efficiency. The flowchart 300 begins with transmitting a packet to a Responder during a transmission opportunity with an indication of a reverse direction grant (element 305). In some embodiments, the reverse direction logic of the Granter may begin a procedure for initiating a reverse direction mode after the Granter finishes transmitting PPDUs such as data to the Responder. In such embodiments, the reverse direction logic may begin with offering an immediate opportunity for the Responder to transmit PPDUs to the Granter.

The Granter may receive a response from the Responder indicating that the Responder has no more data (MPPDU=0) to transmit to the Granter (element 310). In some cases, this may be the last PPDU in a series of PPDU's or may be the only PPDU received from the Responder.

The Granter may determine not to close the TxOP in case either the Granter or the Responder have more PPDUs to transmit so the reverse direction logic may proceed with entry into the defer transmission mode and transmit a PPDU with a response set to immediate or not immediate depending upon the choice of the deferred transmission mode (element 315). The deferred transmission mode may defer transmissions during the TxOP for greater than a PIFS duration and, in some cases, for an undefined period of time. In other embodiments, the deferral duration may be defined but may be greater than a PIFS or a time at which the Responder or Granter will have data to transmit that is longer than any interframe space such as a DIFS.

When entering the deferred transmission mode, some embodiments offer the Granter three or more choices such as a Responder Data transmission rights mode in which the Granter transmits a PPDU requiring an immediate response, Contention-based data transmission rights mode in which the Granter transmits a PPDU without requiring an immediate response, or Grantor data transmission rights mode in which the Granter transmits a PPDU requiring an immediate response (element 320). For instance, the Responder data transmission rights mode may grant data transmission rights of the transmission opportunity during the defer transmission mode to the Responder and the communications between a Granter and the Responder may remain deferred until the Responder transmits a control frame to initiate a transmission to the Granter. In the Responder data transmission rights deferred transmission mode, the Granter may receive a PPDU from the Responder indicative of no more data to transmit (element 325). Then, after a deferral period, the Responder may end the deferral period by initiating transmission of a frame such as a CTS (element 330). In many embodiments, the transmission of the CTS may be at MSC0, allowing the Granter to remain in a low power receive mode while awaiting the end of the deferral period. In other embodiments, the CTS is not used or is optional.

When entering the deferred transmission mode, the Granter may choose the Contention-based data transmission rights mode (element 320). For instance, the Contention-based data transmission rights mode may grant data transmission rights of the transmission opportunity during the deferred transmission mode to either the Granter or the Responder and the communications between a Granter and the Responder may remain deferred until either the Granter or the Responder transmits a frame to initiate a transmission. For instance, the Granter or Responder may end the deferral period by initiating transmission of a control frame such as an RTS (element 335). In many embodiments, the transmission of the RTS may be at MSC0, allowing both the Granter and the Responder to remain in a low power receive mode while awaiting the end of the deferral period. In other embodiments, the RTS is not used or is optional.

When entering the deferred transmission mode, the Granter may choose the Granter data transmission rights mode (element 320). For instance, the Granter data transmission rights mode may grant data transmission rights of the transmission opportunity during the deferred transmission mode to the Granter and the communications between a Granter and the Responder may remain deferred until the Granter transmits a frame to initiate a transmission to the Responder. In the Granter data transmission rights deferred transmission mode, the Granter may receive a PPDU from the Responder indicative of no more data to transmit (element 340). The Granter may transmit a PPDU to the Responder with RDG=0, i.e. no grant of data transmission rights to the Responder (element 345). Then, after a deferral period, the Granter may end the deferral period by initiating transmission of a frame such as an CTS (element 350). In many embodiments, the transmission of the CTS may be at MSC0, allowing the Responder to remain in a low power receive mode while awaiting the end of the deferral period. In other embodiments, the CTS is not used or is optional. In further embodiments, another type of frame such as an RTS may initiate the transmission after the deferral period.

Thereafter, the Granter and the Responder may communicate (element 355) and the data transmission rights of the remainder of the TxOP may return to the Granter (element 360). If there is time remaining in the TxOP (element 365), the Granter may begin the flowchart again starting at element 305. Otherwise, if the TxOP is expired (element 365) or within a threshold time frame such as an interframe space of the end of the TxOP, the TxOP may end.

FIG. 4 depicts an embodiment of a flowchart 400 by a Responder to implement a reverse direction communication procedure. In particular, FIG. 4 depicts an embodiment of a flowchart 400 to enable reverse direction communication with improved power efficiency. The flowchart 400 begins with receiving a packet from a Granter during a transmission opportunity with an indication of a reverse direction grant (element 405). In some embodiments, the reverse direction logic of the Responder may begin a procedure for initiating a reverse direction mode after the Granter finishes transmitting PPDUs such as data to the Responder. In such embodiments, the reverse direction logic may begin with rejecting an immediate opportunity for the Responder to transmit PPDUs to the Granter based upon a lack of, e.g., data available to the Responder to transmit to the Granter.

The Responder may transmit a response to the Granter indicating that the Responder has no more data (MPPDU=0) to transmit to the Granter (element 410). The Responder may determine to proceed with entry into the deferred transmission mode (element 415) if the Granter offers an opportunity to enter into the deferred transmission mode. In some embodiments, the Responder may receive a PPDU requiring an immediate response that may result in a Granter Data transmission rights deferred transmission mode or a Responder Data transmission rights deferred transmission mode or the Responder may receive a PPDU with no immediate response required. The Responder may choose to respond with a PPDU indicating no data to transmit but also with no immediate response (element 425). If the Responder does not receive a response during a PIFS from the Granter then the Responder enters the Responder Data transmission rights mode and may transmit a frame such as a CTS (element 430) to initiate communications. The Granter may not initiate communications after a PIFS after the Responder transmits the PPDU indicating no data to transmit but also with no immediate response.

The Responder may choose to respond with a PPDU indicating no data to transmit but also with an immediate response required (element 440). In this case, the Granter responds with a PPDU with RDG=0 (element 445) and the Granter and Responder enter the Granter Data transmission rights mode. In the Granter data transmission rights mode, the Granter may transmit a CTS to initiate communications (element 450) or, in some embodiments, transmitting a PPDU with RDG=1. The Responder may not initiate communications after the Granter transmits the PPDU with RDG=0 until after receiving the PPDU with RDG=1.

Thereafter, the Granter and the Responder may communicate (element 455) and the data transmission rights of the remainder of the TxOP may return to the Granter (element 460). If there is time remaining in the TxOP (element 465), the Granter may begin the flowchart again starting at element 405. Otherwise, if the TxOP is expired (element 465) or within a threshold time frame such as an interframe space of the end of the TxOP, the TxOP may end.

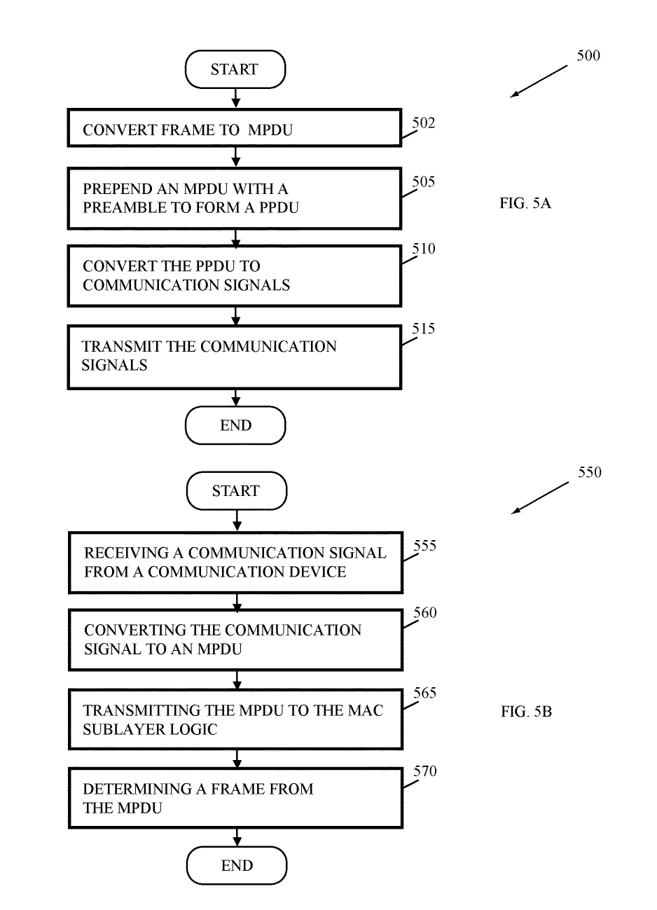

FIGS. 5A-B depict embodiments of flowcharts 500 and 550 to transmit, receive, and interpret communications with a frame. Referring to FIG. 5A, the flowchart 500 may begin with receiving a frame from the frame builder. The MAC sublayer logic of the communications device may generate the frame as a management frame to transmit to an access point, may convert the frame to an MAC protocol data unit (MPDU) (element 502) and transmit the MPDU to a data unit builder to transform the data into a packet that can be transmitted to the access point. The data unit builder may generate a preamble to prepend the PHY service data unit (PSDU) (the MPDU from the frame builder) to form a PHY protocol data unit (PPDU) for transmission (element 505). In some embodiments, more than one MPDU may be prepended in a PPDU.

The PPDU may then be transmitted to the physical layer device such as the transceiver 1020 and 1040 in FIG. 1 so the PPDU may converted to communication signals (element 510). The transmitter may then transmit the communication signals via one or more antennas or an antenna array (element 515).

Referring to FIG. 5B, the flowchart 550 begins with a receiver of a PCP device such as the receiver of transceiver 1040 in FIG. 1 receiving a communication signal via one or more antenna(s) such as an antenna element of antenna(s) 1044 (element 555). The receiver may convert the communication signal into an MPDU in accordance with the process described in the preamble (element 560). More specifically, the received signal is fed from the one or more antennas to a DBF. The output of the DBF is fed to an OFDM module.

The OFDM module may extract signal information from the plurality of subcarriers in each of the frequency segments onto which information-bearing signals are modulated. Then, the demodulator demodulates the signal information via, e.g., BPSK, 16-QAM, 64-QAM, 256-QAM, QPSK, or SQPSK. The signal may be deinterleaved and the frequency segments may then be deparsed.

The decoder may decode the signal information from the demodulator via, e.g., BCC or LDPC, to extract the MPDU (element 560) and transmit the MPDU to MAC sublayer logic such as MAC sublayer logic 1018 (element 565).

The MAC sublayer logic may parse the frame to determine frame field values from the MPDU (element 570). For instance, the MAC sublayer logic may determine frame field values such as the ACK policy field value of the frame to determine whether or not an immediate response is required and a control field to determine whether an RDG is set to a logical 1 or a logical zero.

The following examples pertain to further embodiments. One example comprises an apparatus to determine an adjustment for a schedule. The apparatus may comprise an apparatus to enable reverse direction communication with improved power efficiency, the apparatus comprising: a medium access control logic to transmit a packet to a Responder during a transmission opportunity with an indication of a reverse direction grant; to receive a response to the packet indicative of a lack of data packets to transmit by the Responder; and to enter a defer transmission mode in which transmissions are deferred during the transmission opportunity for greater than a point coordination function interframe space (PIFS) within the transmission opportunity; and a physical layer logic coupled with the medium access control logic to transmit the packet.

In some embodiments, the apparatus may further comprise a processor, a memory coupled with the processor, one or more radios coupled with the physical layer logic. In some embodiments, the apparatus may further comprise one or more antennas coupled with the corresponding one or more radios to receive the information. In some embodiments, the medium access control logic comprises logic to grant data transmission rights of the transmission opportunity during the defer transmission mode to the Responder, wherein communications between a Granter and the Responder are to remain deferred until the Responder transmits a control frame to initiate a transmission to the Granter. In some embodiments, the medium access control logic comprises logic to grant a contention-based data transmission rights of the transmission opportunity during the defer transmission mode, wherein communications between a Granter and the Responder are to remain deferred until the Responder or the Granter transmits a control frame to initiate a transmission. In some embodiments, the medium access control logic comprises logic to grant data transmission rights of the transmission opportunity during the defer transmission mode to the Granter, wherein communications between a Granter and the Responder are to remain deferred until the Granter transmits initiates a transmission to the Granter.

Another embodiment comprises one or more tangible computer-readable non-transitory storage media comprising computer-executable instructions operable to, when executed by at least one computer processor, enable the at least one computer processor to implement a method comprising transmitting a packet to a Responder during a transmission opportunity with an indication of a reverse direction grant; receiving a response to the packet indicative of a lack of data packets to transmit by the Responder; and entering a defer transmission mode in which transmissions are deferred during the transmission opportunity for greater than a point coordination function interframe space (PIFS) within the transmission opportunity.

In some embodiments, entering the defer transmission mode comprises granting data transmission rights of the transmission opportunity during the defer transmission mode to the Responder, wherein communications between a Granter and the Responder are to remain deferred until the Responder transmits a control frame to initiate a transmission to the Granter. In some embodiments, entering the defer transmission mode comprises granting a contention-based data transmission rights of the transmission opportunity during the defer transmission mode, wherein communications between a Granter and the Responder are to remain deferred until the Responder or the Granter transmits a control frame to initiate a transmission. In some embodiments, entering the defer transmission mode comprises granting data transmission rights of the transmission opportunity during the defer transmission mode to the Granter, wherein communications between a Granter and the Responder are to remain deferred until the Granter transmits initiates a transmission to the Granter.

Another embodiment may comprise a method to enable reverse direction communication with improved power efficiency, the method comprising transmitting a packet to a Responder during a transmission opportunity with an indication of a reverse direction grant; receiving a response to the packet indicative of a lack of data packets to transmit by the Responder; and entering a defer transmission mode in which transmissions are deferred during the transmission opportunity for greater than a point coordination function interframe space (PIFS) within the transmission opportunity.

In some embodiments, entering the defer transmission mode comprises granting data transmission rights of the transmission opportunity during the defer transmission mode to the Responder, wherein communications between a Granter and the Responder are to remain deferred until the Responder transmits a control frame to initiate a transmission to the Granter. In some embodiments, entering the defer transmission mode comprises granting a contention-based data transmission rights of the transmission opportunity during the defer transmission mode, wherein communications between a Granter and the Responder are to remain deferred until the Responder or the Granter transmits a control frame to initiate a transmission. In some embodiments, entering the defer transmission mode comprises granting data transmission rights of the transmission opportunity during the defer transmission mode to the Granter, wherein communications between a Granter and the Responder are to remain deferred until the Granter transmits initiates a transmission to the Granter.

In a further embodiment, a system may enable reverse direction communication with improved power efficiency, the system comprising a processor; a memory coupled with the processor; a medium access control logic to transmit a packet to a Responder during a transmission opportunity with an indication of a reverse direction grant; to receive a response to the packet indicative of a lack of data packets to transmit by the Responder; and to enter a defer transmission mode in which transmissions are deferred during the transmission opportunity for greater than a point coordination function interframe space (PIFS) within the transmission opportunity; a physical layer logic coupled with the medium access control logic to transmit the packet; one or more radios coupled with the physical layer logic.

In some embodiments, the apparatus may further comprise one or more antennas coupled with the corresponding one or more radios. In some embodiments, the medium access control logic comprises logic to grant data transmission rights of the transmission opportunity during the defer transmission mode to the Responder, wherein communications between a Granter and the Responder are to remain deferred until the Responder transmits a control frame to initiate a transmission to the Granter. In some embodiments, the medium access control logic comprises logic to grant a contention-based data transmission rights of the transmission opportunity during the defer transmission mode, wherein communications between a Granter and the Responder are to remain deferred until the Responder or the Granter transmits a control frame to initiate a transmission. In some embodiments, the medium access control logic comprises logic to grant data transmission rights of the transmission opportunity during the defer transmission mode to the Granter, wherein communications between a Granter and the Responder are to remain deferred until the Granter transmits initiates a transmission to the Granter.

Another embodiment comprises an apparatus to enable reverse direction communication with improved power efficiency, the apparatus comprising a medium access control logic to receive a packet from a Granter during a transmission opportunity with an indication of a reverse direction grant; to transmit a response to the packet indicative of a lack of data packets to transmit to the Granter; and to enter a defer transmission mode in which transmissions are deferred during the transmission opportunity for greater than a point coordination function interframe space (PIFS) within the transmission opportunity; and a physical layer logic coupled with the medium access control logic to receive the packet.

In some embodiments, the apparatus further comprises a processor, a memory coupled with the processor, one or more radios coupled with the physical layer logic. In some embodiments, the apparatus may further comprise one or more antennas coupled with the corresponding one or more radios to receive the response. In some embodiments, the medium access control logic comprises logic to grant data transmission rights of the transmission opportunity during the defer transmission mode to a Responder, wherein communications between a Granter and the Responder are to remain deferred until the Responder transmits a control frame to initiate a transmission to the Granter. In some embodiments, the medium access control logic comprises logic to grant a contention-based data transmission rights of the transmission opportunity during the defer transmission mode, wherein communications between a Granter and a Responder remain deferred until the Responder or the Granter transmits a control frame to initiate a transmission. In some embodiments, the medium access control logic comprises logic to grant data transmission rights of the transmission opportunity during the defer transmission mode to the Granter, wherein communications between a Granter and a Responder remain deferred until the Granter transmits initiates a transmission to the Granter.

Another embodiment comprises one or more tangible computer-readable non-transitory storage media comprising computer-executable instructions operable to, when executed by at least one computer processor, enable the at least one computer processor to implement a method comprising receiving a packet from a Granter during a transmission opportunity with an indication of a reverse direction grant; transmitting a response to the packet indicative of a lack of data packets to transmit to the Granter; and entering a defer transmission mode in which transmissions are deferred during the transmission opportunity for greater than a point coordination function interframe space (PIFS) within the transmission opportunity.

In some embodiments, entering the defer transmission mode comprises granting data transmission rights of the transmission opportunity during the defer transmission mode to a Responder, wherein communications between the Granter and the Responder are to remain deferred until the Responder transmits a control frame to initiate a transmission to the Granter. In some embodiments, entering the defer transmission mode comprises granting a contention-based data transmission rights of the transmission opportunity during the defer transmission mode, wherein communications between the Granter and a Responder remain deferred until the Responder or the Granter transmits a control frame to initiate a transmission. In some embodiments, entering the defer transmission mode comprises granting data transmission rights of the transmission opportunity during the defer transmission mode to the Granter, wherein communications between the Granter and a Responder remain deferred until the Granter transmits initiates a transmission to the Granter.

Another embodiment may comprise a system to enable reverse direction communication with improved power efficiency, the system comprising a processor; a memory coupled with the processor; a medium access control logic to receive a packet from a Granter during a transmission opportunity with an indication of a reverse direction grant; to transmit a response to the packet indicative of a lack of data packets to transmit to the Granter; and to enter a defer transmission mode in which transmissions are deferred during the transmission opportunity for greater than a point coordination function interframe space (PIFS) within the transmission opportunity; a physical layer logic coupled with the medium access control logic to receive the packet; one or more radios coupled with the physical layer logic.

In some embodiments, the apparatus may further comprise one or more antennas coupled with the corresponding one or more radios. In some embodiments, the medium access control logic comprises logic to grant data transmission rights of the transmission opportunity during the defer transmission mode to a Responder, wherein communications between a Granter and the Responder are to remain deferred until the Responder transmits a control frame to initiate a transmission to the Granter. In some embodiments, the medium access control logic comprises logic to grant a contention-based data transmission rights of the transmission opportunity during the defer transmission mode, wherein communications between a Granter and a Responder remain deferred until the Responder or the Granter transmits a control frame to initiate a transmission. In some embodiments, the medium access control logic comprises logic to grant data transmission rights of the transmission opportunity during the defer transmission mode to the Granter, wherein communications between a Granter and a Responder remain deferred until the Granter transmits initiates a transmission to the Granter.

In some embodiments, a method may enable reverse direction communication with improved power efficiency, the method comprising receiving a packet from a Granter during a transmission opportunity with an indication of a reverse direction grant; transmitting a response to the packet indicative of a lack of data packets to transmit to the Granter; and entering a defer transmission mode in which transmissions are deferred during the transmission opportunity for greater than a point coordination function interframe space (PIFS) within the transmission opportunity.

In some embodiments, entering the defer transmission mode comprises granting data transmission rights of the transmission opportunity during the defer transmission mode to a Responder, wherein communications between the Granter and the Responder are to remain deferred until the Responder transmits a control frame to initiate a transmission to the Granter. In some embodiments, entering the defer transmission mode comprises granting a contention-based data transmission rights of the transmission opportunity during the defer transmission mode, wherein communications between the Granter and a Responder remain deferred until the Responder or the Granter transmits a control frame to initiate a transmission. In some embodiments, entering the defer transmission mode comprises granting data transmission rights of the transmission opportunity during the defer transmission mode to the Granter, wherein communications between the Granter and a Responder remain deferred until the Granter transmits initiates a transmission to the Granter.

Another embodiment may comprise an apparatus to enable reverse direction communication with improved power efficiency, the apparatus comprising: a means for receiving a packet from a Granter during a transmission opportunity with an indication of a reverse direction grant; a means for transmitting a response to the packet indicative of a lack of data packets to transmit to the Granter; and a means for entering a defer transmission mode in which transmissions are deferred during the transmission opportunity for greater than a point coordination function interframe space (PIFS) within the transmission opportunity.

In some embodiments, the means for entering the defer transmission mode comprises granting data transmission rights of the transmission opportunity during the defer transmission mode to a Responder, wherein communications between the Granter and the Responder are to remain deferred until the Responder transmits a control frame to initiate a transmission to the Granter. In some embodiments, the means for entering the defer transmission mode comprises granting a contention-based data transmission rights of the transmission opportunity during the defer transmission mode, wherein communications between the Granter and a Responder remain deferred until the Responder or the Granter transmits a control frame to initiate a transmission. In some embodiments, the means for entering the defer transmission mode comprises granting data transmission rights of the transmission opportunity during the defer transmission mode to the Granter, wherein communications between the Granter and a Responder remain deferred until the Granter transmits initiates a transmission to the Granter.

Another embodiment may comprise an apparatus to enable reverse direction communication with improved power efficiency, the apparatus comprising a means for determining an indication of the duty cycle based upon a thermal measurement, wherein the duty cycle is indicative of a limit on active wireless communication; a means for generating a frame comprising the indication of the duty cycle and a means for transmitting the frame to a personal basic service set control point (PCP) device.

In some embodiments, the means for determining the indication of the duty cycle comprises a means for determining the thermal measurement related to a current duty cycle based upon at least one of power dissipation related to communications and thermal limits associated with the non-PCP device. In some embodiments, the means for generating the frame comprises a means for generating a management frame comprising an information element with the indication of the duty cycle. In some embodiments, the means for generating the frame comprises a means for generating a data frame by a non-PCP device with an indication that the non-PCP device is to enter a power save mode prior to completion of a communication with the PCP device.

In some embodiments, some or all of the features described above and in the claims may be implemented in one embodiment. For instance, alternative features may be implemented as alternatives in an embodiment along with logic or selectable preference to determine which alternative to implement. Some embodiments with features that are not mutually exclusive may also include logic or a selectable preference to activate or deactivate one or more of the features. For instance, some features may be selected at the time of manufacture by including or removing a circuit pathway or transistor. Further features may be selected at the time of deployment or after deployment via logic or a selectable preference such as a dipswitch or the like. A user after via a selectable preference such as a software preference, an e-fuse, or the like may select still further features.

Another embodiment is implemented as a program product for implementing systems and methods described with reference to FIGS. 1-5. Some embodiments can take the form of an entirely hardware embodiment, an entirely software embodiment, or an embodiment containing both hardware and software elements. One embodiment is implemented in software, which includes but is not limited to firmware, resident software, microcode, etc.

Furthermore, embodiments can take the form of a computer program product (or machine-accessible product) accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The logic as described above may be part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product.

What is claimed is:

1. An apparatus to enable reverse direction communication, the apparatus comprising:
a medium access control logic to transmit a packet to a Responder during a transmission opportunity with an indication of a reverse direction grant; to receive a response to the packet indicative of a lack of data packets to transmit by the Responder; and to enter a defer transmission mode in which transmissions are deferred during the transmission opportunity for greater than a point coordination function interframe space (PIFS) within the transmission opportunity; and
a physical layer logic coupled with the medium access control logic to transmit the packet.

2. The apparatus of claim 1, further comprising a processor, a memory coupled with the processor, one or more radios coupled with the physical layer logic.

3. The apparatus of claim 2, further comprising one or more antennas coupled with corresponding ones of the one or more radios.

4. The apparatus of claim 1, wherein the medium access control logic comprises logic to grant data transmission rights of the transmission opportunity during the defer transmission mode to the Responder, wherein communications between a Granter and the Responder are to remain deferred until the Responder transmits a frame to initiate a transmission to the Granter.

5. The apparatus of claim 1, wherein the medium access control logic comprises logic to grant data transmission rights of the transmission opportunity during the defer transmission mode to the Responder, wherein communications between a Granter and the Responder are to remain deferred until the Responder transmits a control frame to initiate a transmission to the Granter.

6. The apparatus of claim 1, wherein the medium access control logic comprises logic to transmit the packet to the Responder during the transmission opportunity with the indication of the reverse direction grant, the packet to comprise a request for an immediate response.

7. The apparatus of claim 1, wherein the medium access control logic comprises logic to grant a contention-based data transmission rights of the transmission opportunity during the defer transmission mode, wherein communications between a Granter and the Responder are to remain deferred until the Responder or the Granter transmits a frame to initiate a transmission.

8. The apparatus of claim 1, wherein the medium access control logic comprises logic to grant data transmission rights of the transmission opportunity during the defer transmission mode to the Granter, wherein communications between a Granter and the Responder are to remain deferred until the Granter transmits a frame to initiate a transmission to the Responder.

9. One or more tangible computer-readable non-transitory storage media comprising computer-executable instructions operable to, when executed by at least one computer processor, enable the at least one computer processor to implement a method comprising:
transmitting a packet to a Responder during a transmission opportunity with an indication of a reverse direction grant;
receiving a response to the packet indicative of a lack of data packets to transmit by the Responder; and
entering a defer transmission mode in which transmissions are deferred during the transmission opportunity for greater than a point coordination function interframe space (PIFS) within the transmission opportunity.

10. The storage media of claim 9, wherein entering the defer transmission mode comprises granting data transmission rights of the transmission opportunity during the defer transmission mode to the Responder, wherein communications between a Granter and the Responder are to remain deferred until the Responder transmits a frame to initiate a transmission to the Granter.

11. The storage media of claim 9, wherein entering the defer transmission mode comprises granting a contention-based data transmission rights of the transmission opportunity during the defer transmission mode, wherein communications between a Granter and the Responder are to remain deferred until the Responder or the Granter transmits a frame to initiate a transmission.

12. The storage media of claim 9, wherein entering the defer transmission mode comprises granting data transmission rights of the transmission opportunity during the defer transmission mode to the Granter, wherein communications between a Granter and the Responder are to remain deferred until the Granter transmits a frame to initiate a transmission to the Responder.

13. A method to enable reverse direction communication, the method comprising:
transmitting a packet to a Responder during a transmission opportunity with an indication of a reverse direction grant;
receiving a response to the packet indicative of a lack of data packets to transmit by the Responder; and
entering a defer transmission mode in which transmissions are deferred during the transmission opportunity for greater than a point coordination function interframe space (PIFS) within the transmission opportunity.

14. The method of claim 13, wherein entering the defer transmission mode comprises deferring communications between the Granter and a Responder until the Responder or the Granter transmits a frame to initiate a transmission.

15. An apparatus to enable reverse direction communication, the apparatus comprising;
a medium access control logic to receive a packet from a Granter during a transmission opportunity with an indication of a reverse direction grant; to transmit a response to the packet indicative of a lack of data packets to transmit to the Granter; and to enter a defer transmission mode in which transmissions are deferred during the transmission opportunity for greater than a point coordination function interframe space (PIFS) within the transmission opportunity; and
a physical layer logic coupled with the medium access control logic to receive the packet.

16. The apparatus of claim 15, further comprising a processor, a memory coupled with the processor, one or more radios coupled with the physical layer logic.

17. The apparatus of claim 16, further comprising one or more antennas coupled with corresponding one or more radios.

18. The apparatus of claim 15, wherein the medium access control logic comprises logic to grant data transmission rights of the transmission opportunity during the defer transmission mode to a Responder, wherein communications between a Granter and the Responder are to remain deferred until the Responder transmits a frame to initiate a transmission to the Granter.

19. The apparatus of claim 15, wherein the medium access control logic comprises logic to receive the packet from the Granter during the transmission opportunity with the indication of the reverse direction grant, the packet to comprise a request for an immediate response.

20. The apparatus of claim 15, wherein the medium access control logic comprises logic to grant a contention-based data transmission rights of the transmission opportunity during the defer transmission mode, wherein communications between a Granter and a Responder remain deferred until the Responder or the Granter transmits a frame to initiate a transmission.

21. The apparatus of claim 15, wherein the medium access control logic comprises logic to grant data transmission rights of the transmission opportunity during the defer transmission mode to the Granter, wherein communications between a Granter and a Responder remain deferred until the Granter transmits a frame to initiate a transmission to the Responder.

22. One or more tangible computer-readable non-transitory storage media comprising computer-executable instructions operable to, when executed by at least one computer processor, enable the at least one computer processor to implement a method comprising:
receiving a packet from a Granter during a transmission opportunity with an indication of a reverse direction grant;
transmitting a response to the packet indicative of a lack of data packets to transmit to the Granter; and
entering a defer transmission mode in which transmissions are deferred during the transmission opportunity for greater than a point coordination function interframe space (PIFS) within the transmission opportunity.

23. The storage media of claim 22, wherein entering the defer transmission mode comprises deferring communications between the Granter and a Responder until the Responder or the Granter transmits a frame to initiate a transmission.

24. A method to enable reverse direction communication, the method comprising:
receiving a packet from a Granter during a transmission opportunity with an indication of a reverse direction grant;
transmitting a response to the packet indicative of a lack of data packets to transmit to the Granter; and
entering a defer transmission mode in which transmissions are deferred during the transmission opportunity for greater than a point coordination function interframe space (PIFS) within the transmission opportunity.

25. The method of claim 24, wherein entering the defer transmission mode comprises deferring communications between the Granter and a Responder until the Responder or the Granter transmits a frame to initiate a transmission.
